(19) United States
(12) Patent Application Publication
(10) Pub. No.: US 2009/0115565 A1
(43) Pub. Date: May 7, 2009

(54) LIQUID METAL RELAY

(75) Inventors: Tetsuya WATANABE, Musashino-shi (JP); Makoto NORO, Musashino-shi (JP); Yoshitaka SUZUKI, Musashino-shi (JP)

Correspondence Address: SUGHRUE-265550, 2100 PENNSYLVANIA AVE. NW, WASHINGTON, DC, 20037-3213, US

(73) Assignee: YOKOGAWA ELECTRIC CORPORATION, Musashino-shi (JP)

(21) Appl. No.: 12/259,099

(22) Filed: Oct. 27, 2008

(30) Foreign Application Priority Data
Nov. 2, 2007 (JP) 2007-286382

(51) Int. Cl. H01H 37/36

(52) U.S. Cl. 337/114

(57) ABSTRACT

A liquid metal relay includes passages formed by bonding a first substrate and a second substrate together, a liquid chamber formed in a middle of the passages, a plurality of electrodes arranged in the liquid chamber, a first gas chamber and a second gas chamber arranged to communicate with both ends of the passages, a gas sealed into the first gas chamber and the second gas chamber, and a heating section for heating the gas, a liquid metal sealed in the liquid chamber, and through electrodes led to an outside of the first substrate from the plurality of electrodes and the heating section.

### TECHNICAL FIELD

The present disclosure relates to a liquid metal relay using a conductive fluid (e.g., mercury, GaIn alloy, GaInSn alloy) and, more particularly, a liquid metal relay capable of achieving higher reliability and lower cost.

### RELATED ART

In the related art, as the relay, the contact operating type relay such as mechanical relay having metal contacts, mercury relay, lead relay, or the like are employed.

A big problem of the relay is a life of contacts. The relay having a long life and high reliability is needed in various fields, but it is the true state that the decisive relay is not present.

On the contrary, the mercury relay has high reliability. However, because this mercury relay causes the problem of environmental pollution and has high cost, such mercury relay is shunned.

The relay in the related art will be explained with reference to FIGS. 5A to 5C hereunder.

FIGS. 5A to 5C are explanatory views showing major configurations of the relay.

FIG. 5A is a plan view, FIG. 5B is a sectional view taken along a-a′ in FIG. 5A, and a sectional view taken along b-b′ in FIG. 5A. In this case, the plan view in FIG. 5A also illustrates respective portions, which are to be illustrated with a dotted line, with a solid line.

In FIGS. 5A to 5C, a first substrate 101 is formed of a rectangular glass as an insulating material. An electrode 102a and an electrode 102b made of a metal thin film are formed in parallel at a predetermined interval on the first substrate 101. An electrode 102c having the same shape and made of a metal thin film is formed between these electrodes 102a, 102b to oppose to these electrodes. These electrodes 102a, 102b, 102c are formed like a sheet respectively, and electrode pads 103a, 103b, 103c are formed at one end respectively. Heaters 104a, 104b whose middle portion is shaped into a meander respectively as shown in the plane view of FIG. 5A are formed on the first substrate 101. The heaters 104a, 104b are connected to electrode pads 103d, 103e formed on the first substrate 101.

A second substrate 105 is a glass that is shaped into a rectangle, like the first substrate 101. The second substrate 105 is fixed to the surface of the first substrate 101, on which the electrodes 102a, 102b, 102c, the heater 104a, and the heater 104b are formed, by an adhesion, or the like. A lateral passage 106 is formed on the fixed surface of the second substrate 105, and a first gas chamber 107a and a second gas chamber 107b are formed on both ends of this passage to communicate with the lateral passage 106 respectively. Also, narrow restrictions 108a, 108d and wide restrictions 108b, 108c are formed in the lateral passage 106 at a predetermined interval. In this related art, the lateral passage 106 is partitioned into three liquid chambers 106a, 106b, 106c by these restrictions.

Also, two through holes 110a, 110b are formed in the second substrate 105 in positions, which oppose to the electrodes 102a, 102b, in the perpendicular direction to the surface of the substrate. Also, vertical passages 111a, 111b that are communicated with the liquid chambers 106a, 106c respectively are formed on bottom portions of the through holes 110a, 110b.

Then, a conductive fluid 112 (e.g., mercury) is sealed into the liquid chambers 106a, 106b, 106c constituting the lateral passage 106 via the through holes 110a, 110b and the vertical passages 111a, 111b.

In this case, the conductive fluid 112 introduced from the right side through hole 110b stops just when this fluid comes up to the liquid chamber 106c of the lateral passage 106.

Also, the restriction 108a between the first gas chamber 107a in which the heater 104a is arranged and the lateral passage 106 is set narrowly to such an extent that the conductive fluid is not moved from the liquid camber 106a toward the first gas chamber 107a by a surface tension of the mercury. Similarly, the restriction 108d between the second gas chamber 107b in which the heater 104b is arranged and the lateral passage 106 is set narrowly to such an extent that the conductive fluid is not moved from the liquid camber 106c toward the second gas chamber 107b by a surface tension of the mercury. The restrictions 108b, 108c for connecting the liquid chambers 106a, 106b, 106c are formed to such an extent that the conductive fluid is not moved toward the adjacent liquid chambers by a surface tension of the mercury in a steady state, but the conductive fluid can be moved when a predetermined pressure is applied to the conductive fluid.

A gas such as an air, a nitrogen gas, or the like, for example, is sealed into the first gas chamber 107a and the second gas chamber 107b. In this case, in order to prevent oxidation of the conductive fluid, the interior of the lateral passage 106 may be evacuated or may be purged by using an inert gas such as nitrogen, argon, or the like before the conductive fluid 112 is introduced. Also, when the hole is blocked by introducing the conductive fluid after the inert gas is introduced in the passage, the inert gas can be sealed. When a reducing gas such as hydrogen, carbon monoxide, or the like or a mixed gas consisting of the inert gas and the reducing gas may be employed instead of the inert gas, the oxidation preventing effect can be further improved.

[Patent Literature 1] Japanese Patent Unexamined Application Publication No. 2006-294505

In the relay in the related art, the substrate is sealed by using the adhesive. Therefore, such a problem existed that a gas such as moisture, oxygen, or the like enters into the inside, in which the heaters and the electrodes are provided, from the portions that are sealed with the adhesive.

Also, since the electrode pads are provided on the outer side, the electric joining to other devices is given by the wire bonding. Therefore, such a problem existed that the high frequency characteristic is poor.

### SUMMARY

Exemplary embodiments of the present invention provide a liquid metal relay whose reliability is high by using the MEMS (micro electro mechanical systems) technology, and also provide a liquid metal relay whose high frequency characteristic is good and whose resistance value is low by providing through electrodes.

In a first aspect of the present invention, a liquid metal relay comprises:

a first substrate;

a second substrate bonded to the first substrate;

a passage formed between the first substrate and the second substrate;

a liquid chamber formed in a middle of the passage;

a plurality of electrodes arranged in the liquid chamber;

a first gas chamber and a second gas chamber arranged to communicate with both ends of the passage, the first and second gas chambers sealing gas respectively;

a heating section for heating the gas sealed in the first and second gas chambers;

a liquid metal sealed in the liquid chamber; and

a through electrode formed in the first substrate and led to an outside of the first substrate from the plurality of electrodes and the heating section.

In a second aspect of the present invention, in the liquid metal relay according to the first aspect, the heating section includes a heater formed on the first substrate like a micro bridge.

In a third aspect of the present invention, in the liquid metal relay according to the first or second aspect, the first substrate and the second substrate are made of glass.

In a fourth aspect of the present invention, in the liquid metal relay according to the third aspect, the first substrate and the second substrate are bonded by a thermocompression bonding.

In a fifth aspect of the present invention, in the liquid metal relay according to the first or second aspect, the second substrate is made of a silicon.

In a sixth aspect of the present invention, in the liquid metal relay according to the fifth aspect, the first substrate and the second substrate are bonded by an anodic bonding.

In a seventh aspect of the present invention, in liquid metal the relay according to any one of the first to sixth aspects, the first substrate has a through hole, on which a metal film is formed, and the through electrode is formed by filling a metal in the through hole by a solder, a conductive paste, or a plating.

The advantages obtained by the representative inventions out of the inventions will be explained as follows.

According to the relay of the present invention, the first substrate and the second substrate are bonded together by the anodic bonding or the thermocompression bonding not to use the adhesive agent. Therefore, such a situation can be prevented that a gas such as moisture, oxygen, or the like enters into the interior, and thus high reliability can be realized.

Because the through electrode is provided, the relay of the present invention can be mounted on an electronic circuit board without employment of the wire bonding. Therefore, the high frequency characteristic can be improved.

The metal such as solder, conductive paste, plating, or the like is filled into the through electrode. Therefore, the metal such as solder, or the like can function as an electric lead wire, and thus a reduction in resistance can be easily attained.

Because such a configuration is employed that the heater is fixed at both ends to be like a micro bridge, a heat is never emitted wastefully. Because the heat is never emitted wastefully, a gas can be warmed effectively in the package. As a result, ON/OFF of the switch can be switched quickly.

Because another package is not needed separately, the relay of the present invention can be mounted directly on a printed substrate, or the like. Because this relay can be mounted directly on a printed substrate, or the like, man-hours required to seal the relay in the package and a packaging cost can be reduced. As a result, a reduction in cost can be achieved.

The electrodes made of silicon that is stable in the liquid metal can be formed.

The heater made of single crystal silicon that is structurally stable and has a long life can be formed. Therefore, the relay of the present invention becomes excellent in durability against the repetitive heating by the heater.

Respective structures of the through electrode, the electrodes made of silicon that is stable in the liquid metal, and the heater made of single crystal silicon that is structurally stable and has a long life can be realized at the same time by the semiconductor technology.

Other features and advantages may be apparent from the following detailed description, the accompanying drawings and the claims.

### BRIEF DESCRIPTION OF THE DRAWINGS

FIGS. 1A to 1C are configurative views showing an example of the present invention.

FIGS. 2A to 2H are process views showing an example of the present invention.

FIGS. 3A to 3C are configurative views showing another example of the present invention.

FIGS. 4A to 4H are process views showing another example of the present invention.

FIGS. 5A to 5C are configurative views showing an example in the related art.

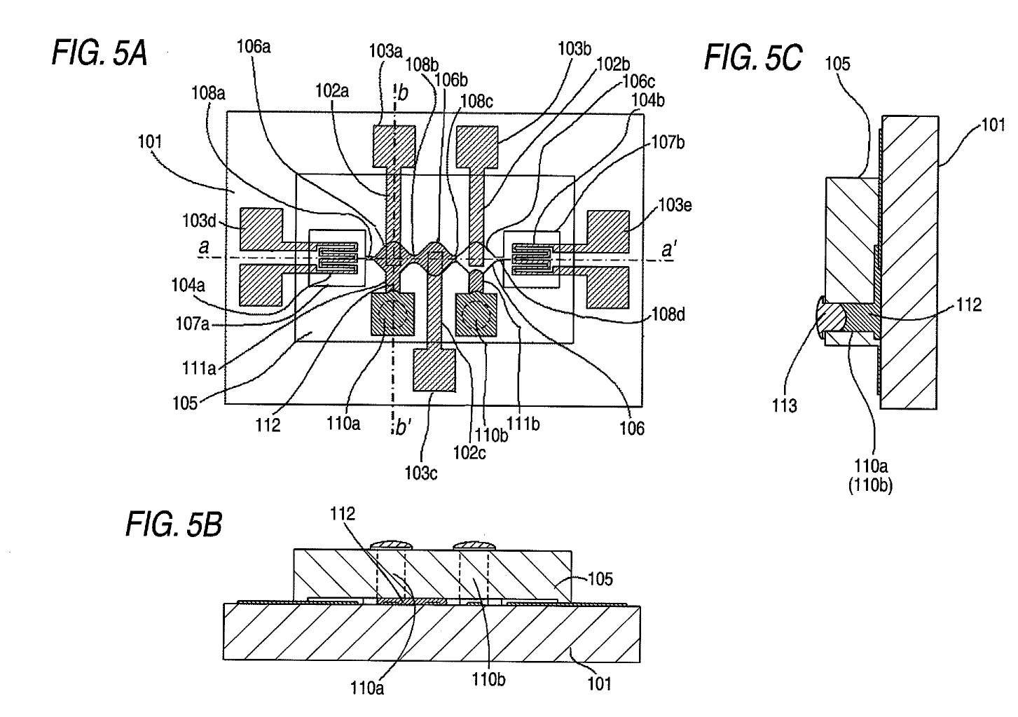

### DETAILED DESCRIPTION

A relay of the present invention will be explained with reference to the drawings hereinafter.

### Embodiment 1

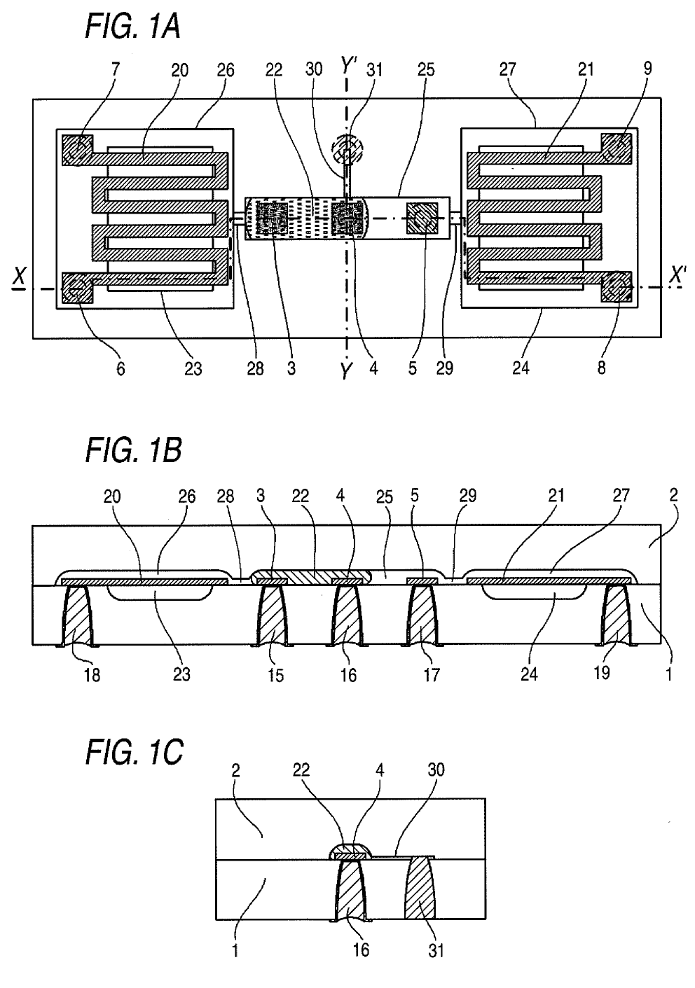

FIGS. 1A to 1C are configurative views showing an example of the present invention.

FIG. 1A is a plan view, FIG. 1B is a sectional view taken along X-X′ in FIG. 1A, and a sectional view taken along Y-Y′ in FIG. 1A. In this case, the plan view in FIG. 1A also illustrates respective portions, which are to be illustrated with a dotted line, with a solid line.

A Pyrex (registered trademark) glass substrate is employed as a first substrate (referred to as a “first glass substrate 1” hereinafter) and a second substrate (referred to as a “second glass substrate 2” hereinafter).

As shown in FIGS. 1A to 1C, the relay comprises passages formed by bonding the first glass substrate 1 and the second glass substrate 2 together (referred to as “connecting passages 28, 29” hereinafter), a liquid chamber 25 formed in the middle of the connecting passages 28, 29, a plurality of electrodes arranged in the liquid chamber 25 (referred to as “contact electrodes 3, 4, 5” hereinafter), a first gas chamber 26 and a second gas chamber 27 arranged to communicate with both ends of the connecting passages 28, 29, a gas sealed in the first gas chamber 26 and the second gas chamber 27 and a heating section for heating the gas (referred to as “heaters 20, 21” hereinafter), a liquid metal 22 sealed in the liquid chamber 25, and through electrodes 15, 16, 17, 18, 19 led from the plurality of contact electrodes 3, 4, 5 and the heaters 20, 21 to the outside of the first glass substrate 1.

Also, the first glass substrate 1 and the second glass substrate 2 are bonded together by a thermocompression bonding, or the like.

The wording “to form the heaters 20, 21 as the heating section on the first glass substrate 1 like a micro bridge” denotes that the heaters 20, 21 are fixed to the first glass substrate 1 as the both ends of recess portions that holds a hollow space respectively (referred to as “recess portions 23, 24 constituting spaces underlying the heaters” hereinafter), by processing areas underlying the heaters 20, 21.

The contact electrodes 3, 4, 5, the heaters 20, 21, the recess portions 23, 24, the through electrodes 15, 16, 17, and the through electrodes 18, 19 are formed on the first glass substrate 1. The contact electrodes 3, 4, 5 are made of silicon in which boron is doped at a high concentration and are used for touching the liquid metal 22. The heaters 20, 21 are made of silicon in which boron is also doped at a high concentration. The recess portions 23, 24 constitute the spaces underlying the heaters 20, 21 respectively. The through electrodes 15, 16, 17 get the electrical conduction from the contact electrodes 3, 4, 5 respectively. The through electrodes 18, 19 get the electrical conduction from both end portions 6, 8 of the heaters 20, 21 respectively.

Here, the through electrodes corresponding to both end portions 7, 9 of the heaters 20, 21 are not illustrated.

The liquid chamber 25 for containing the liquid metal 22, the first gas chamber 26 and the second gas chamber 27, the connecting passages 28, 29 for connecting the liquid chamber 25 to the first gas chamber 26 and the second gas chamber 27, a liquid metal introducing hole 31 for introducing the liquid metal 22, and a liquid metal introducing passage 30 for connecting the liquid metal introducing hole 31 to the liquid chamber 25 are formed on the second glass substrate 2.

Here, FIG. 1C shows a state that the liquid metal introducing hole 31 is blocked by an adhesive agent or a solder after the liquid metal 22 is introduced.

According to the relay of the present invention, the first glass substrate 1 and the second glass substrate 2 are bonded together by the thermocompression bonding. Therefore, it can be prevented that a gas such as moisture, oxygen, or the like enters into the bonded interior, and thus high reliability can be realized.

Because the through electrodes 15, 16, 17, 18, 19 are provided, the relay of the present invention can be mounted on an electronic circuit board without employment of the wire bonding. Therefore, the high frequency characteristic can be improved.

A metal such as solder, conductive paste, plating, or the like is filled into the through electrodes 15, 16, 17, 18, 19. Therefore, the metal such as solder, or the like can function as an electric lead wire, and thus a reduction in resistance can be easily attained.

Because such a configuration is employed that the heaters 20, 21 are fixed to the first glass substrate 1 as both ends of the recess portions 23, 24 that constitute the spaces underlying the heaters 20, 21 respectively, a heat is never emitted wastefully. Also, because the heat is never emitted wastefully, a gas can be warmed effectively in the package. As a result, ON/OFF of the switch can be switched quickly.

Because another package is not needed separately, the relay of the present invention can be mounted directly on a printed substrate, or the like. Also, because this relay can be mounted directly on a printed substrate, or the like, man-hours required to seal the relay in the package and a packaging cost can be reduced. As a result, a reduction in cost can be achieved.

The electrodes made of silicon that is stable in the liquid metal can be formed.

The heater made of single crystal silicon that is structurally stable and has a long life can be formed. Therefore, the relay of the present invention becomes excellent in durability against the repetitive heating by the heater.

Next, an operation of the relay shown in FIGS. 1A to 1C will be explained hereunder.

The liquid metal 22 is sealed such that this liquid metal comes into contact with two contact electrodes out of three contact electrodes 3, 4, 5 made of silicon. The liquid metal 22 does not wet the inner wall of the passage of the glass, and a force that becomes rounded is large because a surface tension is large.

As a result, if a volume of the liquid metal 22 is proper, the liquid metal 22 never simultaneously touches three contact electrodes 3, 4, 5 made of silicon.

In FIG. 1B, the liquid metal 22 touches the contact electrodes 3, 4 made of silicon, but the liquid metal 22 does not touch the contact electrode 5. In this state, the through electrode 15 and the through electrode 16 are electrically conducted, but the through electrode 16 and the through electrode 17 are electrically opened.

Respective spaces of the liquid chamber 25, the first gas chamber 26 and the second gas chamber 27, and the recess portions 23, 24 constituting the spaces underlying the heaters 20, 21 respectively are filled with an inert gas such as nitrogen, argon, or the like or a reducing gas such as hydrogen, ammonia, or the like. Since the liquid metal 22 is moved rightward or leftward by an expanding pressure of a gas generated when the heater 20 or the heater 21 is energized selectively to generate a heat, a function of the relay can be realized.

The first gas chamber 26 and the second gas chamber 27 constituting the spaces overlying the heaters 20, 21 respectively are communicated with the liquid chamber 25 through the connecting passages 28, 29 respectively. A gas when expanded by the heating of the heaters 20, 21 can pass through the connecting passages 28, 29 whose gap dimension is set properly, nevertheless the liquid metal 22 cannot pass through the connecting passages 28, 29 on account of a surface tension of the liquid metal 22.

A gap dimension of the liquid metal introducing passage 30 is set properly. Therefore, even when a pressure of a gas when expanded by the heating of the heaters 20, 21 is applied to the liquid metal 22, the liquid metal 22 cannot enter into the liquid metal introducing passage 30 on account of a surface tension of the liquid metal 22.

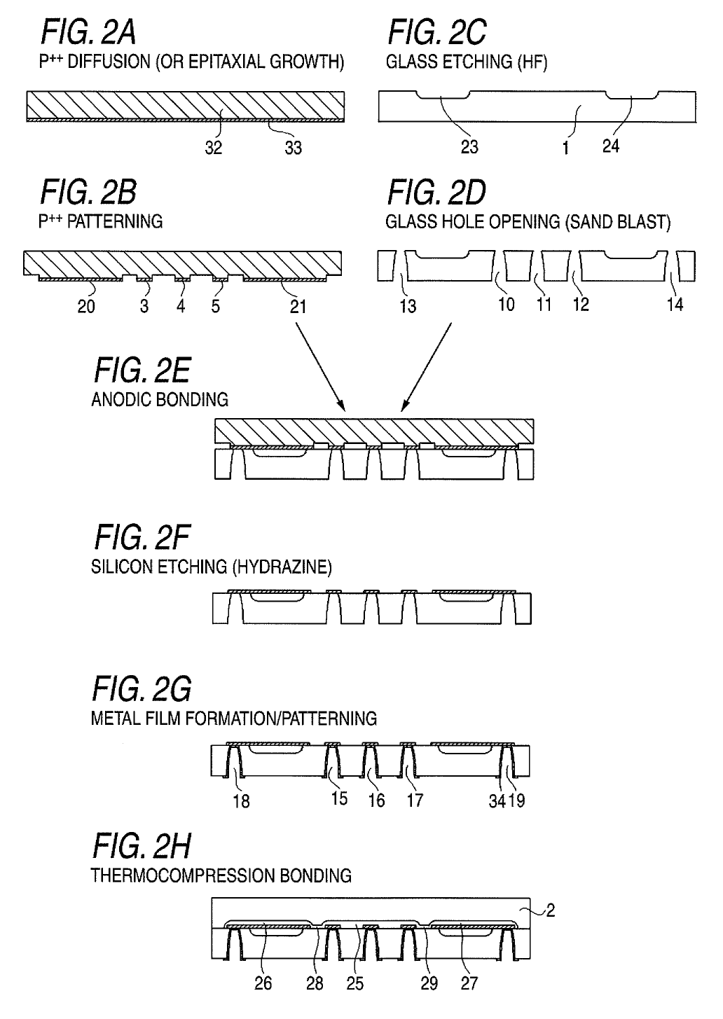

FIGS. 2A to 2H are process views showing an example of manufacturing processes of the relay of the present invention. In FIGS. 2A to 2H, the same reference symbols are affixed to the same portions as those in FIGS. 1A to 1C.

FIGS. 2A to 2H are process views showing another example of manufacturing processes about the heater/electrode made of silicon and the through electrodes of the present invention.

In the relay, as shown in FIG. 2A, first a P⁺⁺-layer 33 (high-concentration boron doped layer) is formed on a silicon substrate 32 by the diffusion, the epitaxial growth, or the like.

Then, as shown in FIG. 2B, respective areas except areas constituting the heaters 20, 21 and areas constituting the contact electrodes 3, 4, 5 made of silicon are removed from the p⁺⁺-layer 33 (high-concentration boron doped layer) by the etching.

Meanwhile, as shown in FIG. 2C, the recess portions 23, 24 constituting the spaces underlying the heaters 20, 21 respectively are processed in the first glass substrate 1 by the etching, or the like.

Then, as shown in FIG. 2D, through holes 10, 11, 12, 13, 14 in which the through electrode is formed respectively are processed in the first glass substrate 1 by the sand blast, or the like.

Here, as shown in FIG. 2E, the silicon substrate 32 processed in step in FIG. 2B and the first glass substrate 1 processed in step in FIG. 2D are bonded by the anodic bonding.

Then, as shown in FIG. 2F, the silicon substrate 32 is removed by the etching using an alkaline liquid such as hydrazine, TMAH, or the like, while leaving only the areas corresponding to the heaters 20, 21 and the contact electrodes 3, 4, 5 made of silicon.

Then, as shown in FIG. 2G, a metal film 34 is formed in the through holes 10, 11, 12, 13 of the first glass substrate 1 and on the bottom of the first glass substrate 1 by the sputtering, or the like. Then, the through electrodes 15, 16, 17, 18, 19 are formed by patterning the metal film 34. The metal film may be formed only on desired portions by using a stencil mask, otherwise the grooves may be cut by the dicing to separate the film after the metal film is formed on the whole surface.

Then, as shown in FIG. 2H, the second glass substrate 2, in which the first gas chamber 26 and the second gas chamber 27, the liquid chamber 25, the connecting passages 28, 29, and the liquid metal introducing passage 30 are processed by the etching, or the like, and the first glass substrate 1 processed in step shown in FIG. 2G are bonded by the thermocompression bonding.

Here, the liquid metal introducing passage 30 is not illustrated in FIGS. 2A to 2H.

According to the relay of the present invention, the first glass substrate 1 and the second glass substrate 2 are bonded together by the thermocompression bonding. Therefore, it can be prevented that a gas such as moisture, oxygen, or the like enters into the bonded interior, and thus high reliability can be realized.

Because the through electrodes 15, 16, 17, 18, 19 are provided, the relay of the present invention can be mounted on the electronic circuit board without employment of the wire bonding. Therefore, the high frequency characteristic can be improved.

The metal such as solder, conductive paste, plating, or the like is filled into the through electrodes 15, 16, 17, 18, 19. Therefore, the metal such as solder, or the like can function as the electric lead wire, and thus a reduction in resistance can be easily attained.

In the relay manufactured by steps containing the lost wafer process in FIGS. 2A to 2H, the recess portions 23, 24 constituting the spaces underlying the heaters 20, 21 respectively can be formed to float the heaters 20, 21 over the first glass substrate 1.

Because the heaters 20, 21 are floated, the heat is never emitted wastefully. Also, because the heat is never emitted wastefully, a gas can be warmed effectively in the package. As a result, ON/OFF of the switch can be switched quickly.

Because another package is not needed separately, the relay of the present invention can be mounted directly on a printed substrate, or the like. Also, because this relay can be mounted directly on the printed substrate, or the like, man-hours required to seal the relay in the package and a packaging cost can be reduced. As a result, a reduction in cost can be achieved.

The contact electrodes 3, 4, 5 made of silicon that is stable in the liquid metal 22 can be formed, and the heaters 20, 21 made of single crystal silicon that is structurally stable and has a long life can be formed.

Because the single crystal silicon is employed, the relay of the present invention is excellent in durability against the repetitive heating by the heater.

### Embodiment 2

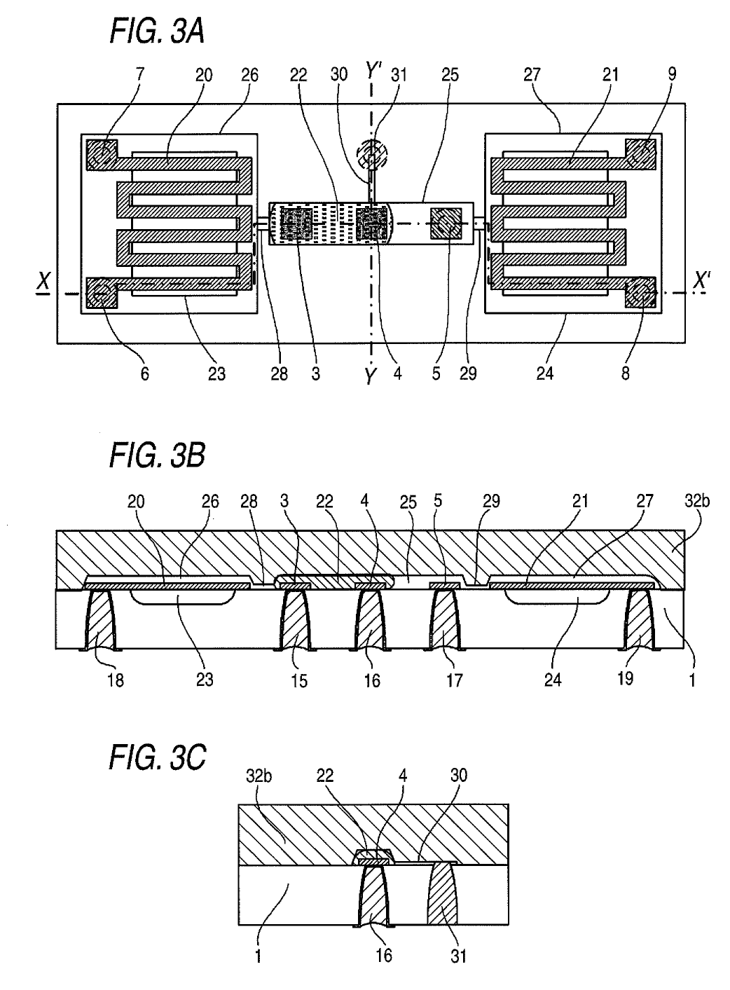

FIGS. 3A to 3C are configurative views showing another example of the relay of the present invention. In FIGS. 3A to 3C, the same reference symbols are affixed to the same portions as those in FIGS. 1A to 1C.

FIG. 3A is a plan view, FIG. 3B is a sectional view taken along X-X′ in FIG. 3A, and a sectional view taken along Y-Y′ in FIG. 3A. In this case, the plan view in FIG. 3A also illustrates respective portions, which are to be illustrated with a dotted line, with a solid line.

A Pyrex (registered trademark) glass substrate is employed as a first substrate (referred to as the “first glass substrate 1” hereinafter).

A silicon substrate is employed as a second substrate (referred to as a “second silicon substrate 32b” hereinafter).

As shown in FIGS. 3A to 3C, the relay comprises passages formed by bonding the first glass substrate 1 and the second silicon substrate 32b together (referred to as “connecting passages 28, 29” hereinafter), a liquid chamber 25 formed in the middle of the connecting passages 28, 29, a plurality of electrodes arranged in the liquid chamber 25 (referred to as “contact electrodes 3, 4, 5” hereinafter), a first gas chamber 26 and a second gas chamber 27 arranged to communicate with both ends of the connecting passages 28, 29, a gas sealed in the first gas chamber 26 and the second gas chamber 27 and a heating section for heating the gas (referred to as “heaters 20, 21” hereinafter), a liquid metal 22 sealed in the liquid chamber 25, and through electrodes 15, 16, 17, 18, 19 led from a plurality of contact electrodes 3, 4, 5 and the heaters 20, 21 to the outside of the first glass substrate 1.

Also, the first glass substrate 1 and the second silicon substrate 32b are bonded together by anodic bonding, or the like.

The wording “to form the heaters 20, 21 as the heating section on the first glass substrate 1 like a micro bridge” denotes that the heaters 20, 21 are fixed to the first glass substrate 1 as the both ends of recess portions that holds a hollow space respectively (referred to as “recess portions 23, 24 constituting spaces underlying the heaters” hereinafter), by processing areas underlying the heaters 20, 21.

The contact electrodes 3, 4, 5, the heaters 20, 21, the recess portions 23, 24, the through electrodes 15, 16, 17, and the through electrodes 18, 19 are formed on the first glass substrate 1. The contact electrodes 3, 4, 5 are made of silicon in which boron is doped at a high concentration and are used for touching the liquid metal 22. The heaters 20, 21 are made of silicon in which boron is also doped at a high concentration. The recess portions 23, 24 constitute the spaces underlying the heaters 20, 21 respectively. The through electrodes 15, 16, 17 get the electrical conduction from the contact electrodes 3, 4, 5 respectively. The through electrodes 18, 19 get the electrical conduction from both end portions 6, 8 of the heaters 20, 21 respectively.

Here, the through electrodes corresponding to both end portions 7, 9 of the heaters 20, 21 are not illustrated.

The liquid chamber 25 for containing the liquid metal 22, the first gas chamber 26 and the second gas chamber 27, the connecting passages 28, 29 for connecting the liquid chamber 25 to the first gas chamber 26 and the second gas chamber 27, a liquid metal introducing hole 31 for introducing the liquid metal 22, and a liquid metal introducing passage 30 for connecting the liquid metal introducing hole 31 to the liquid chamber 25 are formed on the second silicon substrate 32b.

Here, FIG. 3C shows a state that the liquid metal introducing hole 31 is blocked by an adhesive agent or a solder after the liquid metal 22 is introduced.

According to the relay of the present invention, the first glass substrate 1 and the second silicon substrate 32b are bonded together by the anodic bonding. Therefore, it can be prevented that a gas such as moisture, oxygen, or the like enters into the bonded interior, and thus high reliability can be realized.

Because the through electrodes 15, 16, 17, 18, 19 are provided, the relay of the present invention can be mounted on the electronic circuit board without employment of the wire bonding. Therefore, the high frequency characteristic can be improved.

A metal such as solder, conductive paste, plating, or the like is filled into the through electrodes 15, 16, 17, 18, 19. Therefore, the metal such as solder, or the like can function as an electric lead wire, and thus a reduction in resistance can be easily attained.

Because such a configuration is employed that the heaters 20, 21 are fixed to the first glass substrate 1 as both ends of the recess portions 23, 24 that constitute the spaces underlying the heaters 20, 21 respectively, a heat is never emitted wastefully. Also, because the heat is never emitted wastefully, a gas can be warmed effectively in the package. As a result, ON/OFF of the switch can be switched quickly.

Because another package is not needed separately, the relay of the present invention can be mounted directly on a printed substrate, or the like. Because this relay can be mounted directly on a printed substrate, or the like, man-hours required to seal the relay in the package and a packaging cost can be reduced. As a result, a reduction in cost can be achieved.

The electrodes made of silicon that is stable in the liquid metal can be formed. The heater made of single crystal silicon that is structurally stable and has a long life can be formed. Therefore, the relay of the present invention becomes excellent in durability against the repetitive heating by the heater.

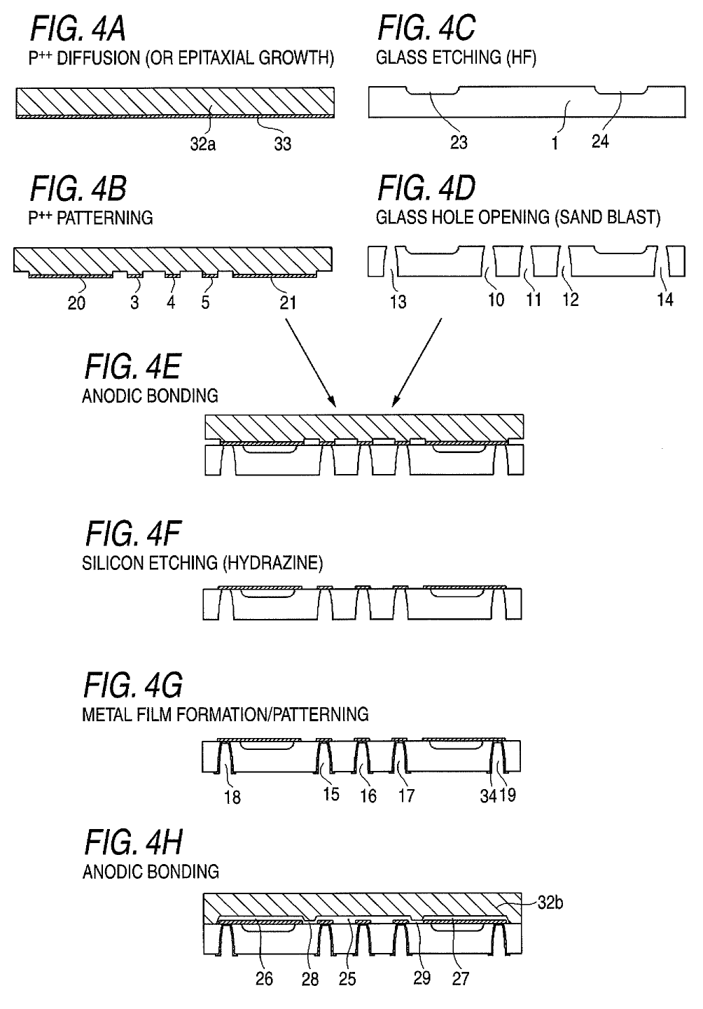

FIGS. 4A to 4H are process views showing another example of manufacturing processes about the heater/electrode made of silicon and the through electrodes of the present invention.

In FIGS. 4A to 4H, the same reference symbols are affixed to the same portions as those in foregoing FIGS. 2A to 2H.

In the relay, as shown in FIG. 4A, first the P⁺⁺-layer 33 (high-concentration boron doped layer) is formed on a first silicon substrate 32a by the diffusion, the epitaxial growth, or the like.

Then, as shown in FIG. 4B, respective areas except areas constituting the heaters 20, 21 and areas constituting the contact electrodes 3, 4, 5 made of silicon are removed from the p⁺⁺-layer 33 (high-concentration boron doped layer) by the etching.

Meanwhile, as shown in FIG. 4C, the recess portions 23, 24 constituting the spaces underlying the heaters 20, 21 respectively are processed in the first glass substrate 1 by the etching, or the like.

Then, as shown in FIG. 4D, the through holes 10, 11, 12, 13, 14 in which the through electrode is formed respectively are processed in the first glass substrate 1 by the sandblast, or the like.

Here, as shown in FIG. 4E, the first silicon substrate 32b processed in step in FIG. 4B and the first glass substrate 1 processed in step in FIG. 4D are bonded by the anodic bonding.

Then, as shown in FIG. 4F, the first silicon substrate 32a is removed by the etching using an alkaline liquid such as hydrazine, TMAH, or the like, while leaving only the areas corresponding to the heaters 20, 21 and the contact electrodes 3, 4, 5 made of silicon.

Then, as shown in FIG. 4G, the metal film 34 is formed in the through holes 10, 11, 12, 13 of the first glass substrate 1 and on the bottom of the first glass substrate 1 by the sputtering, or the like. Then, the through electrodes 15, 16, 17, 18, 19 are formed by patterning the metal film 34. The metal film may be formed only on desired portions by using a stencil mask, otherwise the grooves may be cut by the dicing to separate the film after the metal film is formed on the whole surface.

Then, as shown in FIG. 4H, the second silicon substrate 32b, in which the first gas chamber 26 and the second gas chamber 27, the liquid chamber 25, the connecting passages 28, 29, and the liquid metal introducing passage 30 are processed by the alkaline anisotropic etching, or the like, and the first glass substrate 1 processed in step shown in FIG. 4G are bonded by the anodic bonding.

Here, the liquid metal introducing passage 30 is not illustrated in FIG. 4.

According to the relay of the present invention, the first glass substrate 1 and the second silicon substrate 32b are bonded together by the anodic bonding. Therefore, it can be prevented that a gas such as moisture, oxygen, or the like enters into the bonded interior, and thus high reliability can be realized.

Because the through electrodes 15, 16, 17, 18, 19 are provided, the relay of the present invention can be mounted on the electronic circuit board without employment of the wire bonding. Therefore, the high frequency characteristic can be improved.

The metal such as solder, conductive paste, plating, or the like is filled into the through electrodes 15, 16, 17, 18, 19. Therefore, the metal such as solder, or the like can function as the electric lead wire, and thus a reduction in resistance can be easily attained.

In the relay manufactured by steps containing the lost wafer process in FIGS. 4A to 4H, the recess portions 23, 24 constituting the spaces underlying the heaters 20, 21 respectively can be formed to float the heaters 20, 21 over the first glass substrate 1.

Because the heaters 20, 21 are floated, the heat is never emitted wastefully. Because the heat is never emitted wastefully, a gas can be warmed effectively in the package. As a result, ON/OFF of the switch can be switched quickly.

Because another package is not needed separately, the relay of the present invention can be mounted directly on a printed substrate, or the like. Because this relay can be mounted directly on the printed substrate, or the like, man-hours required to seal the relay in the package and a packaging cost can be reduced. As a result, a reduction in cost can be achieved.

The contact electrodes 3, 4, 5 made of silicon that is stable in the liquid metal 22 can be formed, and the heaters 20, 21 made of single crystal silicon that is structurally stable and has a long life can be formed.

Because the single crystal silicon is employed, the relay of the present invention is excellent in durability against the repetitive heating by the heater.

What is claimed is:

1. A liquid metal relay comprising:
a first substrate;
a second substrate bonded to the first substrate;
a passage formed between the first substrate and the second substrate;
a liquid chamber formed in a middle of the passage;
a plurality of electrodes arranged in the liquid chamber;
a first gas chamber and a second gas chamber arranged to communicate with both ends of the passage, the first and second gas chambers sealing gas respectively;
a heating section for heating the gas sealed in the first and second gas chambers;
a liquid metal sealed in the liquid chamber; and
a through electrode formed in the first substrate and led to an outside of the first substrate from the plurality of electrodes and the heating section.

2. A liquid metal relay according to claim 1, wherein the heating section includes a heater formed on the first substrate like a micro bridge.

3. A liquid metal relay according to claim 1, wherein the first substrate and the second substrate are made of glass.

4. A liquid metal relay according to claim 3, wherein the first substrate and the second substrate are bonded by a thermocompression bonding.

5. A liquid metal relay according to claim 1, wherein the second substrate is made of a silicon.

6. A liquid metal relay according to claim 5, wherein the first substrate and the second substrate are bonded by an anodic bonding.

7. A liquid metal relay according to claim 1, wherein the first substrate has a through hole, on which a metal film is formed, and the through electrode is formed by filling a metal in the through hole by a solder, a conductive paste, or a plating.
